(19) United States
(12) Patent Application Publication
(10) Pub. No.: US 2003/0123174 A1
(43) Pub. Date: Jul. 3, 2003

(54) Continuously variable storage device data transfer rate

(76) Inventors: Mark Hennecken, Parker, CO (US); Robert G. Brocko, Boulder, CO (US)

Correspondence Address: STORAGE TECHNOLOGY CORPORATION, One StorageTek Drive, Louisville, CO, 80028-4309, US

(21) Appl. No.: 10/034,362

(22) Filed: Dec. 28, 2001

(51) Int. Cl. G11B 5/09; G11B 15/46

(52) U.S. Cl. 360/51; 360/73.08

(57) ABSTRACT

A method and apparatus for timing reads and writes to a moving physical storage medium capable of being operated over a continuous range of speeds is disclosed. Reference regions on the moving storage medium are read as the medium moves past a read head. This produces a timing signal, which can be processed to produce a clock signal. This clock signal can then be used to time reads and writes to and from the medium so that the medium may be read or written to at any speed, while preserving the same physical size for each recording item of data on the medium.

### CROSS REFERENCE TO RELATED APPLICATIONS

The present invention is related to an application entitled HIGH FREQUENCY AND LOW FREQUENCY SERVO PATTERN, Ser. No. ______, attorney docket no. 2001-071-TAP, filed even date hereof, assigned to the same assignee, and incorporated herein by reference.

### BACKGROUND OF THE INVENTION

1. Field of the Invention

The present invention is related generally to storage devices, and in particular tape drives, having a variable data rate capability.

2. Background of the Invention

Advances in storage technology in recent years have allowed storage devices to outpace the host computer systems that control them. That is, data can often be recorded to tape or disk faster than a host system can provide the data to the storage device. In the particular case of tape drives, this can be a considerable nuisance. Tapes are generally written to at a fixed speed, so that the physical size of the data as written to tape is a fixed proportion to the length of data being written. If a host system cannot supply enough data for a tape drive to write a constant stream of data at this fixed rate, however, the tape drive must stop, rewind, and continue recording as data becomes available. This is highly inefficient and can impose a considerable amount of wear and tear on the mechanical portion of the tape drive.

Adaptive tape speed systems attempt to remedy the situation by varying the tape speed to match the data rate to/from the host. U.S. Pat. No. 5,892,633, to Ayres, et al., entitled “Dynamic Control of Magnetic Tape Drive,” describes one such system, which relies on a buried (or embedded) servo pattern, normally used to align the read/write head with the tape, to determine the speed of the tape at a given moment and adjust the data rate of data being read or written to/from the tape to match the tape speed. U.S. Pat. No. 6,122,124, to Fasen, et al., entitled “Servo System and Method with Digitally-Controlled Oscillator,” also uses a servo pattern to measure the tape speed and adjust the data rate, except that a timing-based servo is used instead of a buried servo.

Two problems exist with these servo based methods. The first is that if the read/write head is shifted off track center (which is a common occurrence), the timing signals experience phase variations, which affects the quality of the generated clock signal, and thus could cause timing errors. The second is that the low frequency nature of these servo signals requires large multiplication factors to achieve the clock frequencies of interest. This large multiplication factor also has the potential to cause phase variations affecting the quality of the generated clock signal. As the tape drive transfer rates increase, the problems become more acute. What is needed, then, is an adaptive media speed storage device that uses a modified pattern designed specifically for timing measurements.

### SUMMARY OF THE INVENTION

The present invention provides a method and apparatus for timing reads and writes to a moving physical storage medium capable of being operated over a continuous range of speeds. Reference regions on the moving storage medium are read as the medium moves past a read head. This produces a timing signal, which can be processed to produce a clock signal. This clock signal can then be used to time reads and writes to and from the medium so that the medium may be read or written to at any speed, while preserving the same physical size for each recording item of data on the medium.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 is a diagram depicting an overall view of a preferred embodiment of the present invention;

FIG. 2 is a diagram depicting a process of timing-based servo alignment in accordance with a preferred embodiment of the present invention;

FIG. 3 depicts an enhanced servo track in accordance with a preferred embodiment of the present invention;

FIG. 4 is a diagram depicting various configurations of servo tracks that may be used within a preferred embodiment of the present invention;

FIG. 5 is a diagram showing the relation between a servo track containing reference regions and the timing signal and processed timing signal derived therefrom in accordance with a preferred embodiment of the present invention;

FIG. 6 is a block diagram depicting the basic structure of a peak-detecting read channel in accordance with a preferred embodiment of the present invention; and

FIG. 7 is a block diagram of a phase-locked loop (PLL) that may be utilized in a preferred embodiment of the present invention.

### DETAILED DESCRIPTION OF THE PREFERRED EMBODIMENT

FIG. 1 is a diagram depicting an overall view of a preferred embodiment of the present invention. Computer host 100 reads data from and writes data to buffer circuitry 102. Data 104, originally written to buffer circuitry 102 from computer host 100, is transmitted from buffer circuitry 102 to read/write head assembly 106 to be written by read/write head assembly 106 to magnetic tape 108. Conversely data 104 is also read by read/write head assembly 106 from magnetic tape 108 and transmitted to buffer circuitry 102 for temporary storage until read by computer host 100.

Magnetic tape 108 stores data sequentially. That is, one unit of data follows another in sequence as magnetic tape 108 moves in relation to read/write head assembly 106. Thus, magnetic tape 108 is a moving storage medium. Whenever the term “moving storage medium” is used in this document, it means a storage medium that moves in relation to some reading or writing means (e.g., read/write head assembly 106). Thus, for the purposes of this document, a moving storage medium encompasses not only media that move while a reading/writing means stays fixed, but it also encompasses media that stay stationary while the reading/writing means moves. Further, it is also contemplated that a moving storage medium and the reading/writing means may both move relative to an external fixed point of reference. Thus, drums, tapes, disks, and the like, are moving storage media. Also, moving storage media need not be magnetic; moving storage media may also employ optical or other storage technologies.

Magnetic tape 108 moves from source spool 110 to take-up spool 112 in a pulley action from force applied by motor 114. Source spool 110 and take-up spool 112 may exist separately, or may be incorporated into an integrated package, such as a tape cartridge or cassette. Motor 114 may operate at any of a continuous range of possible speeds. The present invention allows data to be written to magnetic tape 108 at a speed that matches the speed of motor 114. In this way, motor 114 can be sped up or slowed down as needed.

For example, if buffer circuitry 102 receives a large amount of data that must be written to magnetic tape 108, motor 114 can be sped up to match the flow of data into buffer circuitry 102. If the amount of data to be written is low, motor 114 can be slowed down. Conversely, computer host 100 is able to read a large amount of data at one time, motor 114 can be sped up to accommodate computer host 100's need for data. If computer host 100 cannot process a large amount of data at present, motor 114 can be slowed down to match the current capacity of computer host 100.

As magnetic tape 108 moves in relation to read/write head assembly 106, read/write head assembly 106 reads a timing signal 116 from reference regions written on magnetic tape 108. This timing signal will increase or decrease in frequency in direct relation to the change in tape speed.

Clock generation circuitry 118 processes timing signal 116 to generate a clock signal 120 that may be used to time the reading and writing of data 104 by buffer circuitry. One of ordinary skill in the art will recognize that memory systems such as buffer circuitry 102 typically rely on some kind of clock signal to time reading and writing operations. One of ordinary skill in the art will thus know how to apply clock signal 120 to time reading and writing of data by buffer circuitry 102, as this is an essential step in the design of any conventional computer system. The reader is directed, however, to Microprocessor-Based Design: A Comprehensive Guide to Hardware Design, by Michael Slater, Prentice Hall, 1989 (ISBN 0-13-582248-3), pp. 97-252, for a detailed account of interfacing with and timing various memory systems known in the art.

Clock generation circuitry 118 preferably includes a peak detector 600 for processing the raw timing signal (116) and converting it into a clean form. Clock generation circuitry 118 also preferably includes a phase-locked loop 700 for providing a reliable signal source having high fidelity to the frequency and phase of timing signal 116, as read from magnetic tape 108.

Data recorded to magnetic tape 108 will preferably be written in the form of several parallel tracks extending longitudinally along a surface of magnetic tape 108. Read/write assembly 106 will preferably contain multiple read heads and write heads for reading and writing to/from these tracks simultaneously. For this to properly occur, however, read/write assembly 106 must be properly aligned in the vertical direction so that the proper read and write heads are aligned with the proper tracks. The mechanism for doing this is preferably some kind of timing-based servo system. In a timing-based servo, a servo signal 116 is read from one or more special servo tracks on magnetic tape 108, and preferably processed by peak detector 600 before being fed into and interpreted by servo control 124. This signal is recorded on magnetic tape 108 such that changing the vertical alignment of read/write head assembly 106 changes servo signal 122. Servo control 124 interprets servo signal 122 and keeps read/write head assembly 106 aligned properly by using solenoid 126 to magnetically move read/write head assembly 106 in response to changes in servo signal 122.

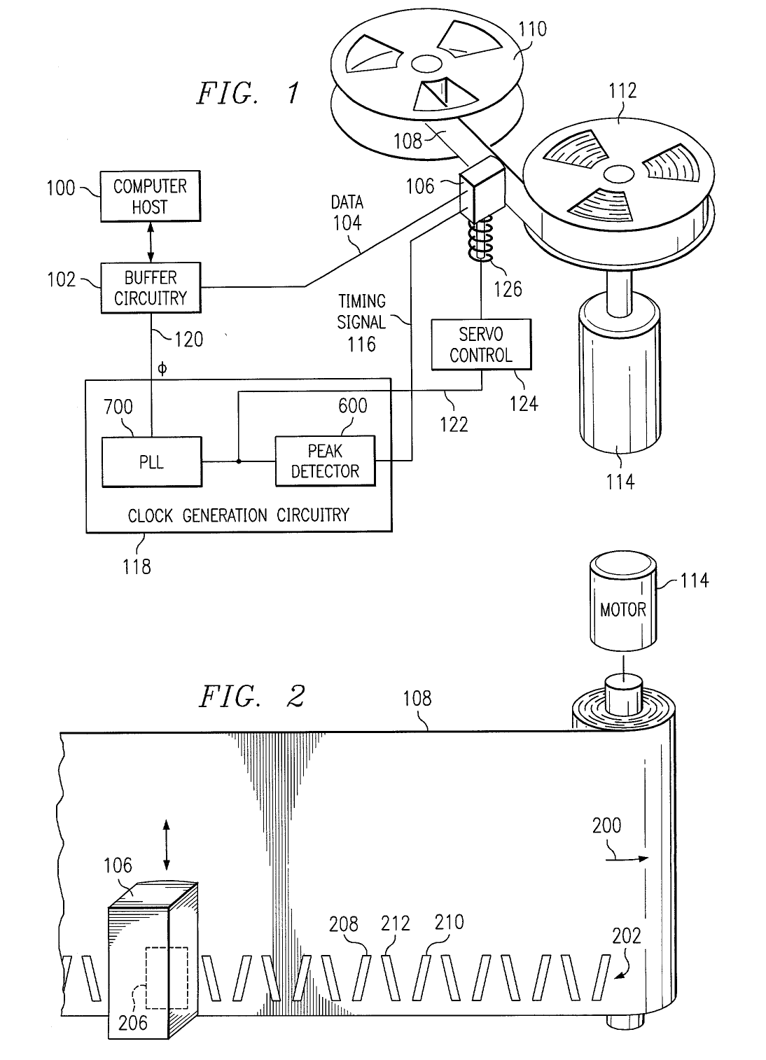

FIG. 2 depicts the process of timing-based servo alignment, in accordance with a preferred embodiment of the present invention, in more detail. Motor 114 pulls magnetic tape 108 in direction 200. Servo track 202 moves past head assembly 106, which includes servo read head 206. Servo read head 206 reads servo track 202 as it move past. Servo track 202 contains a number of slanted regions (e.g., 208, 210, 212) in a repeated “chevron” pattern. Each of these regions (which may also be referred to as “fields”) contains a number of consecutive magnetic flux reversals (also called “transitions”) at a particular frequency. Servo read head 206 only reads a small vertical portion of each region, however. Thus, depending on the vertical alignment of servo read head 206, certain regions may appear closer together or further away.

For example, if servo read head 206 is misaligned, so that it skims the tops of regions 208, 210, and 212, regions 208 and 212 will appear close together, while regions 212 and 210 will appear far apart. Conversely, if servo read head 206 is misaligned in the opposite direction (down), then regions 208 and 212 will appear far apart with regions 212 and 210 appearing close together. With servo read head 210 aligned in the center of this band, regions 208, 212, and 210 will appear equally spaced. Thus, servo control 124 can keep read/write head assembly 106 aligned by adjusting the alignment of read/write head assembly 106 to keep the regions properly spaced.

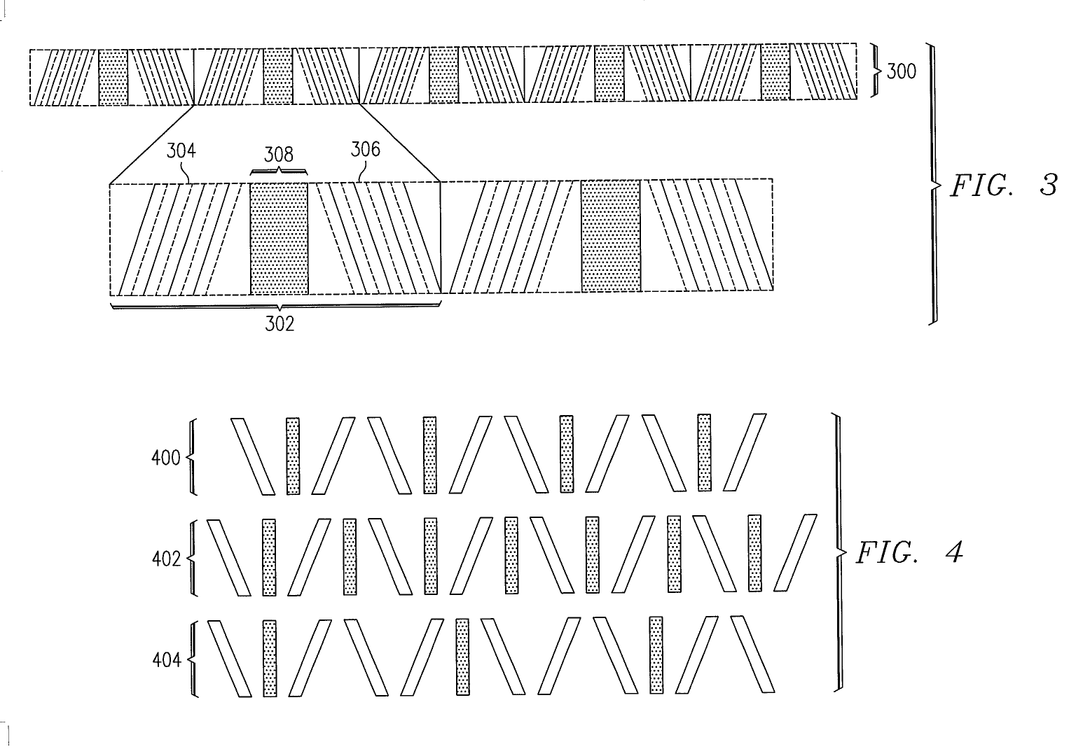

The present invention, however, is not particularly concerned with the vertical alignment of read/write head assembly 106, but is, rather, directed toward the timing of reading and writing of data 104 between buffer circuitry 102 and magnetic tape 106. FIG. 3 depicts an enhanced servo track 300 in accordance with a preferred embodiment of the present invention. As before, servo track 300 contains a number of chevrons, such as chevron 302. In addition to diagonal regions 304 and 306, however, a vertical reference region 308 is included.

Reference region 308 is recorded as a series of flux reversals, just as diagonal regions 304 and 306, but is preferably recorded with different frequency flux reversals, so that reference region 308 can be distinguished from diagonal regions 304 and 306 through the use of a bandpass or other filter, as shown in FIG. 6. In an alternative embodiment, reference region 308 can be modulated so as to contain additional information, such as information regarding the current location on the tape.

As the references regions pass by read/write head assembly 106 and are read, a timing signal (116 in FIG. 1) is produced with a frequency that matches the frequency at which the reference regions are read. A vertical reference region, such as reference region 308 is preferable to diagonal regions 304 and 306 for generating a timing signal. This is because the timing signal read from a vertical reference region does not change in frequency, phase, or pulse width as the read/write head assembly moves up or down, unlike a timing-based servo signal.

FIG. 4 is a diagram depicting various configurations of servo tracks that may be used within the present invention. FIG. 4 is not intended to be exhaustive, but it merely intended to demonstrate that various configurations are possible. Servo track 400 is an inverted version of servo track 300 from FIG. 3. Servo track 402 contains reference regions between every two diagonal regions. Servo track 404 contains reference regions every three diagonal regions away. One of ordinary skill in the art will recognize that many such configurations of reference regions within servo tracks may be employed. One of ordinary skill will also recognize that the reference regions may reside on a track by themselves, with no diagonal regions at all. In such a situation, no timing-based servo information need be on the tape at all, as other head-alignment techniques could be used, including, but not limited to, an embedded servo.

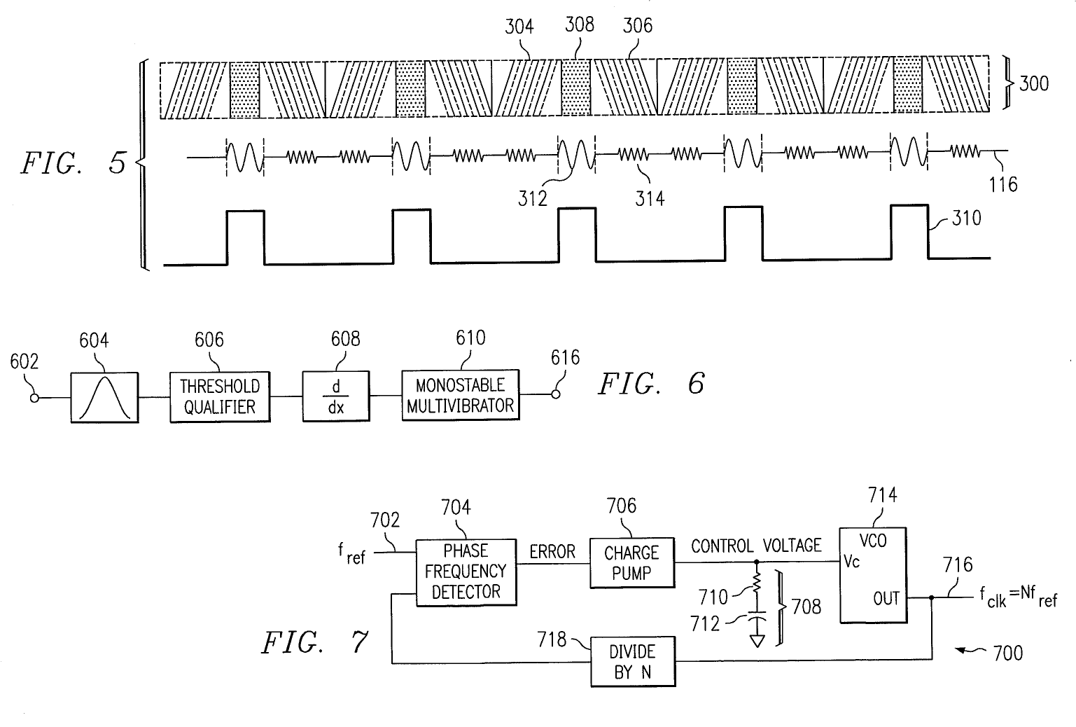

FIG. 5 is a diagram showing the relation between a servo track (300) containing reference regions (e.g., 308), and the timing signal (116) and processed timing signal (310) derived therefrom. As each reference region (e.g., 308) is read by read/write head assembly 106 (FIG. 1), a corresponding waveform 312 is read from magnetic tape 108. Likewise, when a diagonal region such as diagonal region 306 is read, a waveform 314 of a different frequency is produced. Peak detecting read channel 600, shown in FIG. 6, processes timing waveforms such as waveform 312 and produces processed timing signal 310, which is used to enable the circuit illustrated in FIG. 7. The result of FIG. 7 is a clock signal that is phase-locked to signal 312.

FIG. 6 is a block diagram depicting the basic structure of a peak-detecting read channel 600 in accordance with a preferred embodiment of the present invention. Input 602 is, in this case, timing signal 116 from FIG. 1. A bandpass filter 604 filters out all but the signal read from the reference regions (e.g., reference region 308) of the tape. The output of bandpass filter is fed into threshold qualifier 606, which admits only those signals with an amplitude that exceeds a certain threshold. Threshold qualifier 606 serves to eliminate spurious low amplitude signals that may cause differentiator 608 to produce erroneous results.

The output of threshold qualifier 606 is fed into differentiator 608. Differentiator 608, when fed with a waveform from threshold qualifier 606, produces output spikes, which are short-lived transient signals having a relatively high voltage. As the output of differentiator 608 is fed into monostable multivibrator 610, the output spikes serve to trigger monostable multivibrator 610. When monostable multivibrator 610 is triggered, it enters into a quasi-stable state during which an output pulse at output 616 is produced. While reference region 308 is being read and the signal read therefrom is processed by differentiator 608, output spikes are continuously fed into monostable multivibrator 610, thus keeping monostable multivibrator in the quasi-stable state. When the timing signal from reference region 308 ends, no more output spikes are fed into monostable multivibrator 610, and monostable multivibrator 610 after a short time returns to its stable state, which ends the pulse generated at output 616. As the timing signals from successive reference regions are read, monostable multivibrator 610 is triggered repeatedly, thus generating a clock signal at output 616.

FIG. 7 is a block diagram of a phase-locked loop (PLL) that may be utilized in a preferred embodiment of the present invention. The input to the phase locked loop is reference frequency 702, which is fed into phase detector 704. In a preferred embodiment, reference frequency 702 is the processed timing signal from output 616 of peak-detecting read channel 600 (FIG. 6). The other input to the phase detector will be discussed below. The output of phase detector 704 is fed into charge pump 706. (It should be noted that many, but not all PLLs include charge pumps; some simply couple the phase detector directly to the low-pass filter.) The charge pump creates a current for the period of time during which the phase error exists. This signal is filtered through low-pass filter 708 to obtain a voltage Vc, which is fed into voltage controlled oscillator (VCO) 714. The low-pass filter 708 shown is made up of a resistor 710 and capacitor 712 together in series, but placed in shunt with the output of charge pump 706. Various higher-order filters may be used, but low-pass filter 708, as depicted, provides the basic building block for higher order filters. The significance of low-pass filter 708's structure will be discussed shortly. VCO 714's output (716) is the frequency output from the circuit and equals N*f_{ref}. Output 716 drives data transfer clock signal 120, which is used by buffer circuitry 102 to time reading and writing operations.

This signal is also fed into frequency divider 718 that divides f_{clk} by N, which is an integer value in the range of 1, 2, . . . , N₁. The output of frequency divider 718 equals f_{clk}/N at steady-state, and this is the second input to phase detector 704. This completes the feedback loop. Since both inputs to phase detector 704 equal f_{clk}/N, any shift in one of these frequencies will be detected by phase detector 704 and feed through charge pump 706 to voltage controlled oscillator 714. This results in f_{clk} being adjusted to bring it back into sync to a value N*f_{ref}. This in sync condition is known as being “in lock,” hence the name phase-locked loop.

At steady-state, one skilled in the art will recognize that the voltage Vc will be a DC constant. For instance, when a PLL is used as a frequency synthesizer, Vc will largely stay constant. The low-pass filter of a PLL is therefore designed to block out spurious AC signals that may corrupt Vc.

In many cases, however, the reference voltage will vary over time. One commonly encountered situation where this occurs is when a PLL is used to demodulate frequency-modulated (FM) radio signals. In an FM radio signal, the frequency of the signal is constantly changing. Thus, there is a need to be able to rapidly re-obtain lock.

The structure of low-pass filter 708 addresses these dual concerns. Capacitor 712 drains away high-frequency signal components to ground, thus spurious AC signals are prevented from reaching VCO 714. Capacitor 712 by itself, however, makes for a rather unstable system, and particularly so because it is coupled to charge pump 706. Instantaneous changes in the reference frequency can result in ringing at a lone shunt capacitor. This translates into a slower lock, since the ringing must die down before a stable lock is established. Thus, resistor 710 is placed in series with capacitor 712 to provide a damping effect. This damping reduces the degree and length of ringing, so that lock may be more rapidly obtained.

In an alternative embodiment, low-pass filter 708 may be replaced or supplemented with digital signal processing circuitry, such as a digital filter, to provide programmability for different operating conditions. The analog control voltage Vc can be converted into a digital representation by means of a digital-to-analog converter, processed using digital signal processing circuitry, then reconverted back into an analog signal using an analog-to-digital converter.

In another alternative embodiment, PLL 700 is operated in a dual mode configuration. PLL 700 is first operated in a high gain mode to quickly acquire lock. Once lock is achieved, PLL 700 is then changed to a low-gain mode to provide a more stable clock (i.e., one that experiences less phase noise). The gain change may be implemented in filter 708 (either using a digital filter or an active analog filter) by incorporating some form of amplification (e.g., by multiplying digital values or by using an operational or other amplifier).

The description of the present invention has been presented for purposes of illustration and description, and is not intended to be exhaustive or limited to the invention in the form disclosed. Many modifications and variations will be apparent to those of ordinary skill in the art. For example, one of ordinary skill will recognize that the techniques of the present invention may be applied to any moving storage medium, including disks; the invention is not limited to magnetic tapes or any other type of tape or tape-like storage medium. The embodiment was chosen and described in order to best explain the principles of the invention, the practical application, and to enable others of ordinary skill in the art to understand the invention for various embodiments with various modifications as are suited to the particular use contemplated.

What is claimed is:

1. A method of establishing a data transfer rate, comprising:
reading a timing signal from a plurality of reference regions on a moving storage medium, wherein the moving storage medium moves at a speed in a first direction and the reference regions extend in a second direction; and
writing data to the moving storage medium at a rate proportional to the speed of the moving storage medium.

2. The method of claim 1, wherein the second direction is perpendicular to the first direction.

3. The method of claim 1, further comprising:
locking a variable frequency oscillator to the timing signal to generate a data transfer rate.

4. The method of claim 3, wherein locking the variable-frequency oscillator includes bringing a phase-locked loop into lock.

5. The method of claim 3, wherein the variable-frequency oscillator is a voltage-controlled oscillator.

6. The method of claim 1, further comprising:
reading data from the moving storage medium at a rate proportional to the speed of the moving storage medium.

7. The method of claim 1, wherein the moving storage medium is a tape.

8. The method of claim 7, wherein the tape is magnetic tape.

9. The method of claim 1, wherein the moving storage medium is a disk.

10. The method of claim 9, wherein the disk is one of a magnetic disk and an optical disk.

11. The method of claim 1, wherein the reference regions reside on at least one track from a plurality of tracks located on the moving storage medium.

12. The method of claim 11, wherein the reference regions are interleaved with a timing-based servo pattern located on the moving storage medium.

13. An apparatus, comprising:
a voltage-controlled oscillator having a control input and an output;
phase detector having a first input, a second input, and an output; and
a first read head,
wherein the first read head reads reference regions from a moving storage medium, which is moving relative to the first read head, to generate a timing signal, the timing signal is coupled to the first input of the phase detector, the output of the phase detector is fed into the control input of the voltage-controlled oscillator, and the output of the voltage-controlled oscillator is coupled to the second input of the phase detector, whereby the voltage-controlled oscillator produces a signal representing a data transfer rate.

14. The apparatus of claim 13, further comprising:
a filter,
wherein the output of the phase detector is coupled to the control input of the voltage-controlled oscillator through the filter.

15. The apparatus of claim 14, wherein the filter includes a digital filter.

16. The apparatus of claim 14, wherein the filter includes an analog filter.

17. The apparatus of claim 13, further comprising:
a memory buffer; and
a write head,
wherein the write head writes data from the memory buffer to the moving storage medium at a rate proportional to the data transfer rate.

18. The apparatus of claim 13, further comprising:
a memory buffer; and
a second read head,
wherein the second read head reads data from the moving storage medium into the memory at a rate proportional to the data transfer rate.

19. The apparatus of claim 13, wherein the reference regions are located on at least one track of the moving storage medium.

20. The apparatus of claim 13, wherein the reference regions extend in an extension direction that is different from a direction of motion of the moving storage medium.

21. The apparatus of claim 20, wherein the extension direction is perpendicular to the direction of motion of the moving storage medium.

22. The apparatus of claim 13, wherein the reference regions are interleaved with a timing-based servo pattern located on the moving storage medium.

23. A storage medium product comprising:
a recording surface having at least one servo track,
wherein the servo track includes a plurality of servo bands interleaved with a plurality of reference regions.

24. The storage medium product of claim 23, wherein the recording surface has a direction of motion.

25. The storage medium product of claim 24, wherein the direction of motion is circular.

26. The storage medium product of claim 24, wherein the direction of motion is linear.

27. The storage medium product of claim 24, wherein the reference regions extend in an extension direction that is different than the direction of motion.

28. The storage medium product of claim 27, wherein the extension direction is perpendicular to the direction of motion.

29. The storage medium product of claim 23, wherein the reference regions are recorded at a first frequency and the servo bands are recorded at a second frequency that is distinct from the first frequency.
